(19) United States
(12) Patent Application Publication
(10) Pub. No.: US 2013/0244483 A1
(43) Pub. Date: Sep. 19, 2013

(54) COAXIAL CABLE CONNECTOR HAVING A COLLAPSIBLE CONNECTOR BODY

(71) Applicant: PPC BROADBAND, INC., East Syracuse, NY (US)

(72) Inventor: NOAH MONTENA, Syracuse, NY (US)

(73) Assignee: PPC BROADBAND, INC., East Syracuse, NY (US)

(21) Appl. No.: 13/803,025

(22) Filed: Mar. 14, 2013

Related U.S. Application Data
(60) Provisional application No. 61/610,496, filed on Mar. 14, 2012.

(51) Int. Cl. H01R 24/38; H01R 43/26

(52) U.S. Cl. CPC H01R 24/38; H01R 43/26
USPC 439/578; 29/857

(57) ABSTRACT

A connector body comprising a body portion having one or more weakened portions disposed across the body portion to structurally weaken the body portion along a discontinuous revolution around the body portion, wherein upon axial compression of the connector body, the one or more weakened portions of the body portion buckle inward towards a coaxial cable to securely fasten the coaxial cable connector to the coaxial cable is provided. Furthermore, an associated method is also provided.

### CROSS-REFERENCE TO RELATED APPLICATION

This non-provisional application claims priority to U.S. Application No. 61/610,496, filed Mar. 14, 2012, and entitled “Coaxial Cable Connector Having A Collapsible Stamped Connector Body.”

### FIELD OF TECHNOLOGY

The following relates to connectors used in coaxial cable communication applications, and more specifically to a coaxial cable connector having a connector body configured to fasten to the coaxial cable.

### BACKGROUND

Reliable designs for connectors to fasten to cable exist in the art, but the art has reached a fundamental cost barrier relating to the number of components necessary to effectively fasten the connector to the cable. Efforts to combine parts which may then become separate during compression offer possible cost savings, but also present challenges relating to repeatable separation. Other designs rely on a deformable portion of the connector body that has been selectively weakened by difficult machining techniques. However, what designs using deformable portions of the connector body achieve in part reduction, it loses in process cost and material cost. Typically, the deformable connector body is made of thick brass, which not only drives up the material cost of the connector, but increases the difficulty surrounding the actual production of the component. Moreover, it is desirable to maintain electrical continuity through the connector and onto a port to create a RF shield that prevents ingress and egress of electromagnetic noise.

Thus, a need exists for a coaxial cable connector having a connector body that reliably fastens the connector to the cable to allow a reduction in total components of the connector, while also reducing overall costs.

### SUMMARY

A first aspect relates generally to a connector body comprising a body portion having one or more weakened portions disposed across the body portion to structurally weaken the body portion along a discontinuous revolution around the body portion, wherein upon axial compression of the connector body, the one or more weakened portions of the body portion buckle inward towards a coaxial cable to securely fasten the coaxial cable connector to the coaxial cable.

A second aspect relates generally to a connector body for a coaxial cable connector, the connector body comprising a body portion having a first end and a second end, a plurality of weakened body portions disposed circumferentially around the body portion, and a plurality of openings in the body portion located between the plurality of weakened body portions, wherein the plurality of weakened body portions are configured to buckle in a radially inward direction upon axial compression to engage a cable jacket of a coaxial cable, thereby fastening the connector body to the coaxial cable.

A third aspect relates generally to a coaxial cable connector configured to securely attach to a coaxial cable comprising a coupling member operably attached to a post, the post configured to receive a prepared end of the coaxial cable, a collapsible connector body having one or more weakened portions disposed across a body portion of the collapsible connector body, and a sleeve member configured to radially surround at least a portion of the collapsible connector body, wherein upon axial compression of the connector body, the one or more weakened portions of the connector body buckle inward towards the coaxial cable to securely fasten the coaxial cable connector to the coaxial cable.

A fourth aspect relates generally to a method of securing a connector body to a coaxial cable, comprising providing a connector body having a body portion, forming one or more weakened portions across the body portion of the connector body to structurally weaken the body portion along a discontinuous revolution around the body portion, wherein the forming of the one or more weakened portions across the body portion of the connector body facilitates a collapse of the body portion when the connector body is axially compressed, the collapse of the body portion in a radially inward direction towards the coaxial cable securely fastens the connector body to the coaxial cable.

The foregoing and other features of construction and operation of the invention will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a cross-sectional view of a first embodiment of a coaxial cable connector including an embodiment of a connector body in a first position;

FIG. 2 depicts a side view of an embodiment of a coaxial cable;

FIG. 3 depicts a perspective view of an embodiment of the connector body;

FIG. 4A depicts a cross-sectional view of a second embodiment of a coaxial cable connector including an embodiment of a connector body in a first position;

FIG. 4B depicts a cross-sectional view of the second embodiment of the coaxial cable connector including an embodiment of the connector body in a second position;

FIG. 5 depicts a cross-sectional view of a third embodiment of a coaxial cable connector including an embodiment of a connector body in a first position;

FIG. 6 depicts a cross-sectional view of a first embodiment of a coaxial cable connector including an embodiment of a connector body in a first position, with a coaxial cable inserted therein;

FIG. 7 depicts a cross-sectional view of the first embodiment of a coaxial cable connector including an embodiment of a connector body in a second position, attached to the coaxial cable;

FIG. 8 depicts a cross-sectional view of an embodiment of the connector body in the first position;

FIG. 9 depicts a cross-sectional view of an embodiment of the connector body in the second position;

FIG. 10 depicts a cross-sectional view of the second embodiment of a coaxial cable connector including an embodiment of a connector body in the second position, attached to the coaxial cable; and

FIG. 11 depicts a cross-sectional view of the third embodiment of a coaxial cable connector including an embodiment of a connector body in the second position, attached to the coaxial cable.

### DETAILED DESCRIPTION

Although certain embodiments of the present invention are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

As a preface to the detailed description, it should be noted that, as used in this specification and the appended claims, the singular forms “a”, “an” and “the” include plural referents, unless the context clearly dictates otherwise.

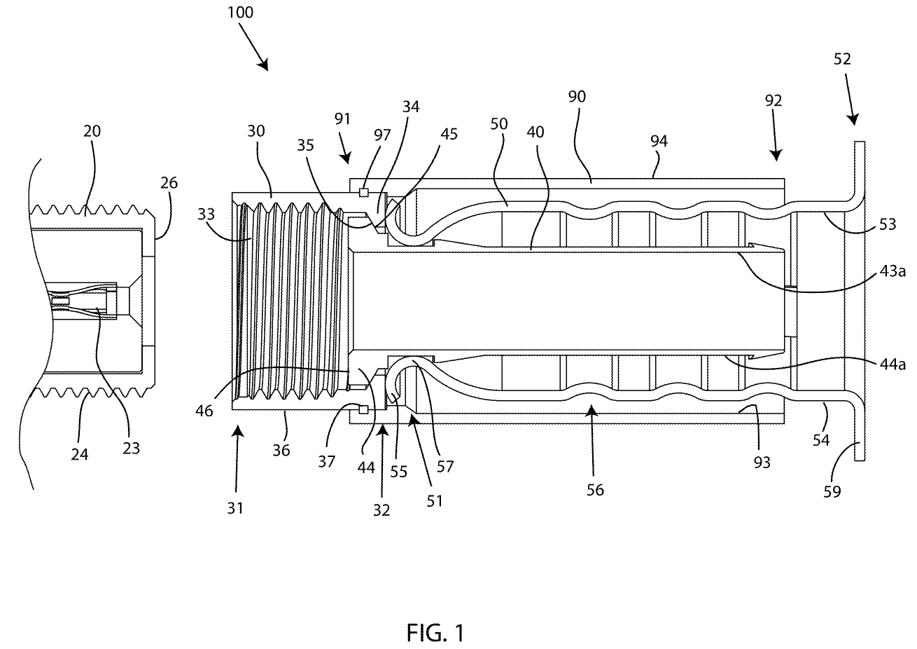

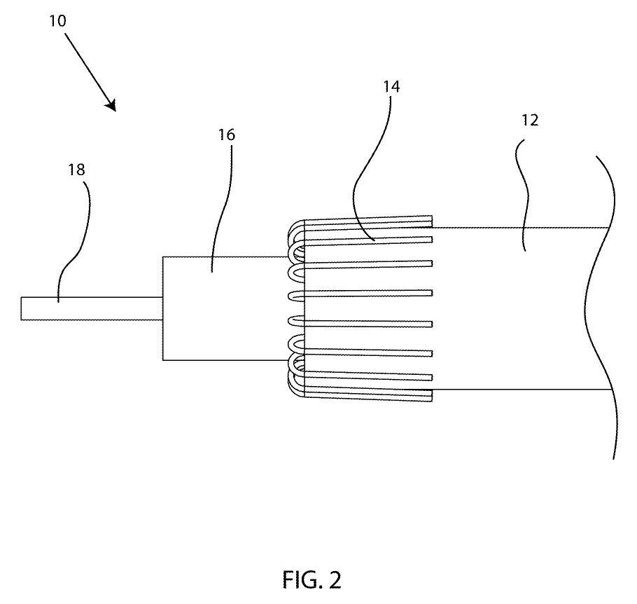

Referring to the drawings, FIG. 1 depicts an embodiment of a coaxial cable connector 100. The coaxial cable connector 100 may be operably affixed, or otherwise functionally attached, to a coaxial cable 10 having a protective outer jacket 12, a conductive grounding shield 14, an interior dielectric 16 and a center conductor 18 (the cable 10 being shown in FIG. 2). The coaxial cable 10 may be prepared as embodied in FIG. 2 by removing the protective outer jacket 12 and drawing back the conductive grounding shield 14 to expose a portion of the interior dielectric 16. Further preparation of the embodied coaxial cable 10 may include stripping the dielectric 16 to expose a portion of the center conductor 18. The protective outer jacket 12 is intended to protect the various components of the coaxial cable 10 from damage which may result from exposure to dirt or moisture and from corrosion. Moreover, the protective outer jacket 12 may serve in some measure to secure the various components of the coaxial cable 10 in a contained cable design that protects the cable 10 from damage related to movement during cable installation. The conductive grounding shield 14 may be comprised of conductive materials suitable for providing an electrical ground connection, such as cuprous braided material, aluminum foils, thin metallic elements, or other like structures. Various embodiments of the shield 14 may be employed to screen unwanted noise. For instance, the shield 14 may comprise a metal foil wrapped around the dielectric 16, or several conductive strands formed in a continuous braid around the dielectric 16. Combinations of foil and/or braided strands may be utilized wherein the conductive shield 14 may comprise a foil layer, then a braided layer, and then a foil layer. Those in the art will appreciate that various layer combinations may be implemented in order for the conductive grounding shield 14 to effectuate an electromagnetic buffer helping to preventingress of environmental noise that may disrupt broadband communications. The dielectric 16 may be comprised of materials suitable for electrical insulation, such as plastic foam material, paper materials, rubber-like polymers, or other functional insulating materials. It should be noted that the various materials of which all the various components of the coaxial cable 10 are comprised may have some degree of elasticity allowing the cable 10 to flex or bend in accordance with traditional broadband communication standards, installation methods and/or equipment. It should further be recognized that the radial thickness of the coaxial cable 10, protective outer jacket 12, conductive grounding shield 14, interior dielectric 16 and/or center conductor 18 may vary based upon generally recognized parameters corresponding to broadband communication standards and/or equipment.

Referring back to FIG. 1, a connector, such as connector 100 may also interact with a coaxial cable interface port 20. The coaxial cable interface port 20 includes a conductive receptacle 23 for receiving a portion of a coaxial cable center conductor 18 sufficient to make adequate electrical contact. The coaxial cable interface port 20 may further comprise a threaded exterior surface 24 and a mating edge 26. The mating edge 26 may be a front face of the port 20 that is configured to make electrical contact with a mating edge 46 of the post 40. It should be recognized that the radial thickness and/or the length of the coaxial cable interface port 20 and/or the conductive receptacle of the port 20 may vary based upon generally recognized parameters corresponding to broadband communication standards and/or equipment. Moreover, the pitch and height of threads which may be formed upon the threaded exterior surface 24 of the coaxial cable interface port 20 may also vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials corresponding to the port's 20 operable electrical interface with a connector 100. However, the receptacle of the port 20 can be formed of a conductive material, such as a metal, like brass, copper, or aluminum. Further still, it can be understood by those of ordinary skill that the interface port 20 may be embodied by a connective interface component of a coaxial cable communications device, a television, a modem, a computer port, a network receiver, or other communications modifying devices such as a signal splitter, a cable line extender, a cable network module and/or the like.

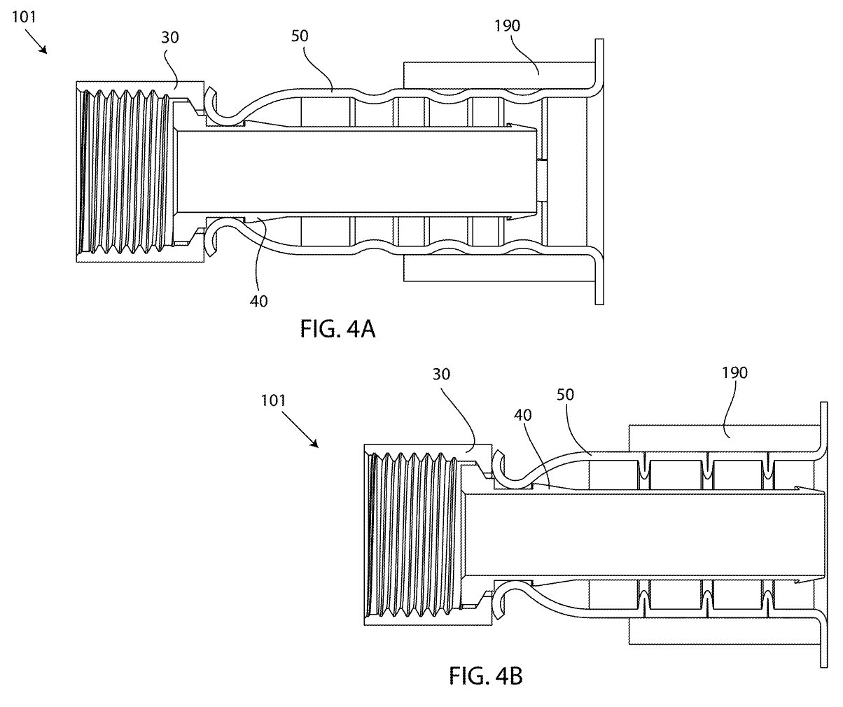

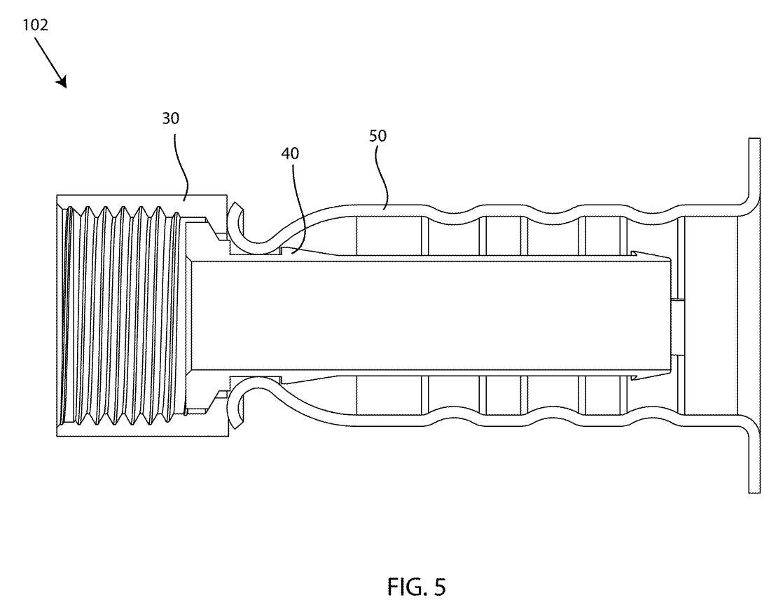

Referring now to FIG. 1, embodiments of a coaxial cable connector 100 may further comprise a coupling member 30, a post 40, a connector body 50, and an outer sleeve 90. Connector 100 may come in a preassembled configuration or may require additional operable attachment of the sleeve 90 to connector 100 during installation. Embodiments of connector 101 may include an outer sleeve 190 as opposed to sleeve 90, as shown in FIGS. 4A and 4B, and described in greater detail infra. Embodiments of connector 102, as shown in FIG. 5, may not include an outer sleeve 90 or outer sleeve 190. Embodiments of connector 100 are described with respect to a F-type connector; however, those having skill in the art should appreciate that connector 100 may be a BNC connector, SMA connector, N male connector, N female connector, UHF connector, DIN connectors, and the like. For instance, each type of coaxial cable connector may include a collapsible connector body, as shown and described in association with a F-type connector.

Referring still to FIG. 1, embodiments of connector 100 may include a coupling member 30. The coupling member 30 of embodiments of a coaxial cable connector 100 has a first forward end 31 and opposing second rearward end 32. The coupling member 30 may comprise internal threading 33 extending axially from the edge of first forward end 31a distance sufficient to provide operably effective threadable contact with the external threads 24 of a standard coaxial cable interface port 20. The coupling member 30 includes an internal lip 34, such as an annular protrusion, located proximate the second rearward end 32 of the coupling member 30. The internal lip 34 includes a surface 35 facing the first forward end 31 of the coupling member 30. The forward facing surface 35 of the lip 34 may be a tapered surface or side facing the first forward end 31 of the coupling member 30. However, the internal lip 34 of coupling member 30 may define the second end 32a of the coupling member 30, eliminating excess material from the coupling member 30. Located somewhere on the outer surface 36 of the coupling member 30 may be a retaining structure 37. The retaining structure 37 of the coupling member 30 may be an annular groove or recess that extends completely or partially around the outer surface 36 of the coupling member 30 to retain, accommodate, receive, or mate with an engagement member 97 of the sleeve 90. Alternatively, the retaining structure 37 may be an annular protrusion that extends completely or partially around the outer surface 36 of the coupling member 30 to retain or mate with the engagement member 97 of the outer sleeve 90. The retaining structure 37 may be placed at various axial positions from the first end 31 to the 32, depending on the configuration of the sleeve 90 and other design requirements of connector 100.

Moreover, embodiments of coupling member 30 may include an outer surface feature(s) 38 proximate or otherwise near the second end 32 to improve mechanical interference or friction between the coupling member 30 and the sleeve 90. For instance, the outer surface feature 38 may extend completely or partially around the outer surface 36 proximate the second 32 of the coupling member 30 to increase a retention force between an inner surface 93 of the sleeve 90 and the outer surface 36 of the coupling member 30. The outer surface feature 38 may include a knurled surface, a slotted surface, a plurality of bumps, ridges, grooves, or any surface feature that may facilitate contact between the sleeve 90 and the coupling member 30. Those having skill in the requisite art should appreciate that embodiments of coupling member 30 may not include a retaining structure 37 or surface feature(s) 38. For example, in embodiments such as connector 102 shown in FIG. 5 that do not include an outer sleeve 90, it may not be necessary for the coupling member 30 to include a retaining structure 37 or surface feature(s) 38.

The structural configuration of the coupling member 30 may vary according differing connector design parameters to accommodate different functionality of a coaxial cable connector 100. Those in the art should appreciate that the coupling member 30 need not be threaded. Moreover, the coupling member 30 may comprise a coupler commonly used in connecting RCA-type, BNC-type connectors, N-female, wireless DIN connectors, SMA connectors, N male connectors, UHF connectors, or other common coaxial cable connectors having coupler interfaces configured to mate with a port. The coupling member 30 may be formed of conductive materials, such as copper, brass, aluminum, or other metals or metal alloys, facilitating grounding through the coupling member 30. Further embodiments of the coupling member 30 may be formed of polymeric materials and may be non-conductive. Accordingly, the coupling member 30 may be configured to extend an electromagnetic buffer by electrically contacting conductive surfaces of an interface port 20 when a connector 100 is advanced onto the port 20. In addition, the coupling member 30 may be formed of both conductive and non-conductive materials. For example the external surface of the coupling member 30 may be formed of a polymer, while the remainder of the coupling member 30 may be comprised of a metal or other conductive material. The coupling member 30 may be formed of metals or polymers or other materials that would facilitate a rigidly formed coupling member body. Manufacture of the coupling member 30 may include casting, extruding, cutting, knurling, turning, tapping, drilling, injection molding, blow molding, combinations thereof, or other fabrication methods that may provide efficient production of the component. The forward facing surface 35 of the coupling member 30 may faces a flange 44 the post 40 when connector 100 is operably assembled in a connector 100, so as to allow the coupling member 30 to rotate with respect to the other component elements, such as the post 40 and the connector body 50, of the connector 100, yet may still hinder or prevent axial movement with respect to those components.

With continued reference to FIG. 1, and additional reference to FIG. 4, embodiments of connector 100 may include a post 40. The post 40 may include a first forward end 41, an opposing second rearward end 42, an inner surface 43a, and an outer surface 43b. Furthermore, the post 40 may comprise a flange 44, such as an externally extending annular protrusion, located at the first end 41 of the post 40. The flange 44 includes a rearward facing surface 45 that may face the forward facing surface 35 of the coupling member 30 when the connector 100 is operably assembled. The rearward facing surface 45 of flange 44 may be a tapered surface facing the second rearward end 42 of the post 40. Further still, an embodiment of the post 40 may include a surface feature such as a lip or protrusion that may engage a portion of a connector body 50 to secure axial movement of the post 40 relative to the connector body 50. However, the post need not include such a surface feature, and the coaxial cable connector 100 may rely on press-fitting and friction-fitting forces and/or other component structures having features and geometries to help retain the post 40 in secure location both axially and rotationally relative to the connector body 50. The location proximate or near where the connector body is secured relative to the post 40 may include surface features, such as ridges, grooves, protrusions, or knurling, which may enhance the secure attachment and locating of the post 40 with respect to the connector body 50. Moreover, various components having larger or smaller diameters can be readily press-fit or otherwise secured into connection with each other. Additionally, the post 40 may include a mating edge 46, which may be configured to make physical and electrical contact with a corresponding mating edge 26 of an interface port 20. The post 40 can be formed such that portions of a prepared coaxial cable 10 including the dielectric 16 and center conductor 18 (examples shown in FIG. 2) may pass axially into the second end 42 and/or through a portion of the tube-like body of the post 40. Moreover, the post 40 can be dimensioned, or otherwise sized, such that the post 40 may be inserted into an end of the prepared coaxial cable 10, around the dielectric 16 and under the protective outer jacket 12 and conductive grounding shield 14. Accordingly, where an embodiment of the post 40 may be inserted into an end of the prepared coaxial cable 10 under the drawn back conductive grounding shield 14, substantial physical and/or electrical contact with the shield 14 may be accomplished thereby facilitating grounding through the post 40. The post 40 can be conductive and may be formed of metals or may be formed of other conductive materials that would facilitate a rigidly formed post body. In addition, the post may be formed of a combination of both conductive and non-conductive materials. For example, a metal coating or layer may be applied to a polymer of other non-conductive material. Manufacture of the post 40 may include casting, extruding, cutting, turning, drilling, knurling, injection molding, spraying, blow molding, component overmolding, combinations thereof, or other fabrication methods that may provide efficient production of the component.

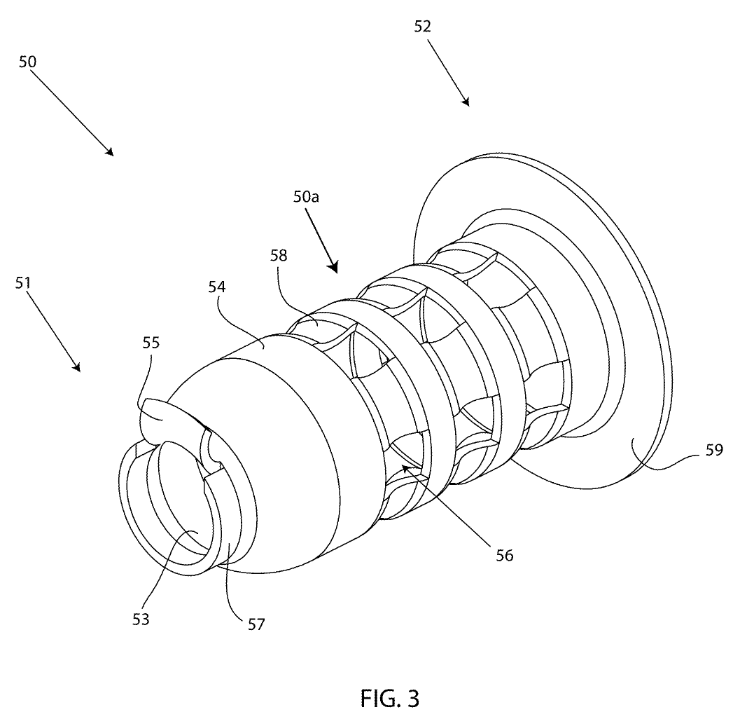

Referring again to FIG. 1, and also FIG. 3, embodiments of a coaxial cable connector, such as connector 100, may include a connector body 50. The connector body 50 may comprise a first end 51, opposing second end 52, an inner surface 53, and an outer surface 54. The connector body 50 may be undergo permanent deformation resulting in a thin-walled body that can be formed by employing machining techniques such as stamping, deep draw, and the like, and/or a combination of manufacturing techniques. The thin wall of the connector body 50 may result in one or more weakened portion 58 along one or more proscribed bands at one or more locations around a body portion 50a of the connector body 50. The connector body 50 may be further weakened by one or more openings 56 located between, adjacent, proximate, or otherwise near the weakened portion 58. Embodiments of connector body 50 may include one or more openings 56 disposed around or partially around the connector body 50 in an annular or semi-annular pattern. Further embodiments of the connector body 50 may include a plurality of weakened body portions 58 and/or a plurality of openings 56 disposed circumferentially around the body portion 50a. Alternatively, the openings 56 may not follow a rigid pattern, but may located at random locations along the body 50 that, when the body 50 is compressed, fasten the body 50 to the cable 10. Embodiments of the openings 56 may be openings, holes, voids, piercing, perforations, and the like to the thin walled body of the connector body 50. In some embodiments, the one or more weakened portions 58 of the connector body 50 may result from the creation of the one or more openings 56.

Furthermore, embodiments of connector body 50 may include a body portion 50a having one or more weakened portions 58 disposed across the body portion 50a to structurally weaken the body portion 50a along a discontinuous revolution around the body portion 50a. The revolution may be discontinuous because the body portion 50a need not be structurally weakened continuously around the body portion 50a. For example, a given revolution around the body portion 50a may not be continuous and be interrupted by a plurality of openings 56 separating the weakened portion 58 of the connector body 50. Alternatively, a given revolution around the body portion 50a may not be continuous and be interrupted by unweakened or weakened portions of the body portion 50a separating a plurality of openings 56. Therefore, embodiments of the connector body 50 may be weakened at one or more locations in across/around the body portion 50a, as opposed to a continuous revolution of weakened structure; the connector body 50 may have a discontinuously weakened structure.

Moreover, the weakened portions 58, upon axial compression, may buckle inward towards the cable 10 to fasten the connector body 50 to the cable 10, as described in greater detail infra. In addition to weakening the thin walled body of the connector body 50, the plurality of openings 56 may conveniently provide visibility into the connector 100, depending upon placement, which may afford the installer an advantageous view of the cable as it is inserted within the connector 100, allowing the installer to assess proper insertion depth. For example, connector 101, as shown in FIGS. 4A and 4B, may include an outer sleeve 190 positioned such that the openings 56 are exposed, providing visibility to the installer.

Furthermore, the connector body 50 may include a continuity portion 55 configured to make physical and electrical contact with the coupling member 30 to extend electrical continuity between the connector body 50 and the coupling member 30. For instance, proximate the first end 51 of the connector body 50, a continuity portion 55, or a plurality of continuity portions 55, may be flared out, or bent slightly backward and upward, to contact the second end 32 of the coupling member 30. The continuity portion 55 of the connector body 50 may comprise just a portion of the first end 51, or may comprise the entire first end 51 of the connector body 50 that has been modified to make contact with the second end 32 of the coupling member 30. The continuity portion 55 of the connector body 50 may eliminate the need for a separate electrical continuity element, thus reducing the total number of components used in the connector assembly. Embodiments of the continuity portion 55 may be an integral resilient continuity member configured to extend electrical continuity between the coupling member 30 and the connector body 50.

Moreover, the connector body may include a post mounting portion 57 proximate or otherwise near the first end 51 of the body 50, the post mounting portion 57 configured to securely locate the body 50 relative to a portion of the outer surface of post 40, so that the connector body 50 is axially secured with respect to the post 40, in a manner that prevents the two components from moving with respect to each other in a direction parallel to the axis of the connector 100. The internal surface of the post mounting portion 57 may include an engagement feature, such as an annular detent or ridge having a different diameter than the rest of the post mounting portion 57. However other features such as grooves, ridges, protrusions, slots, holes, keyways, bumps, nubs, dimples, crests, rims, or other like structural features may be included. The connector body 50 may also include an annular protrusion 59 located proximate or close to the second end 52 of the connector body 50. The annular protrusion 59 may help facilitate the movement of the outer sleeve 190, as shown in FIGS. 4A and 4B, during compression of the connector body 50. The annular protrusion 59 may also provide additional surface area for a compression tool head to engage during axial compression of the connector body 50. The connector body 50 may be formed of materials such as metals, bendable metals, or similar materials that are conducive to creating a thin-walled body capable of being weakened by openings 56. Further, the connector body 50 may be formed of conductive materials. Manufacture of the connector body 50 may include machining, stamping, deep draw techniques, combinations thereof, or other fabrication methods that may provide efficient production of the component.

With continued reference to FIG. 1, embodiments of connector 100 may include a sleeve 90. The sleeve 90 may be engageable with the coupling member 30. The sleeve 90 may include a first end 91, a second end 92, an inner surface 93, and an outer surface 94. The sleeve 90 may be a generally annular member having a generally axial opening therethrough. The sleeve 90 may be radially disposed over the coupling member 30, or a portion thereof, the post 40, or a portion thereof, and the connector body 50, or a portion thereof, while operably assembled. In other words, the outer sleeve 90 may cover the connector body 50 to block moisture entry paths of the connector body 50 if outdoor use is intended, or to block dust and other contaminants in an indoor environment.

Proximate or otherwise near the first end 91, the sleeve 90 may include an engagement member 97 configured to mate or engage with the retaining structure 37 of the coupling member 30. The engagement member 97 may be an annular lip or protrusion that may enter or reside within the retaining structure 37 of the coupling member 30. For example, in embodiments where the retaining structure 37 is an annular groove, the engagement member 97 may be a protrusion or lip that may snap into the groove located on the coupling member 30 to retain the sleeve 90 in a single axial position. In other words, the cooperating surfaces of the groove-like retaining structure 37 and the lip or protruding engagement member 97 may prevent axial movement of the sleeve 90 once the connector 100 is in an assembled configuration. Alternatively, the engagement member 97 may be an annular groove or recess that may receive or engage with the retaining structure 37 of the coupling member 30. For example, in embodiments where the retaining structure 37 of the coupling member 30 is an annular protrusion, the engagement member 97 may be a groove or recess that may allow the annular protruding retaining structure 37 of the coupling member 30 to snap into to retain the sleeve 90 in a single axial position. In other words, the cooperating surfaces of the protruding retaining structure 37 and the groove-like engagement member 97 may prevent axial movement of the sleeve 90 once the connector 100 is in an assembled configuration. Those having skill in the art should understand that various surface features effectuating cooperating surfaces between the coupling member 30 and the sleeve 90 may be implemented to retain the sleeve 90 with respect to the rest of the connector 100 in an axial direction. Furthermore, the engagement member 97 of the sleeve 90 may be segmented such that one or more gaps may separate portions of the engagement member 97, while still providing sufficient structural engagement with the retaining structure 37.

An embodiment of an assembled configuration of connector 100 with respect to the sleeve 90 may involve sliding the sleeve 90 over the coupling member 30 in an axial direction starting from the first end 31 and continuing toward the second end 32 of the coupling member 30 until sufficient mating and/or engagement occurs between the engagement member 97 of the sleeve 90 and the retaining structure 37 of the coupling member 30, as shown in FIG. 1. Once in the assembled configuration, rotation of the sleeve 90 may in turn cause the coupling member 30 to simultaneously rotate in the same direction as the sleeve 90 due to mechanical interference between the inner surface 93 of the sleeve 90 and the outer surface 36 of the coupling member 30. In some embodiments, the interference between the sleeve 90 and the coupling member 30 relies simply on a friction fit or interference fit between the components. Other embodiments include a coupling member 30 with an outer surface feature(s) 38, as described supra, to improve the mechanical interference between the components. Further embodiments include a sleeve 90 with internal surface features positioned on the inner surface 93 to improve the contact between the components. Even further embodiments of connector 100 may include a sleeve 90 and a coupling member 30 both having surface features. Embodiments of the inner surface features of the sleeve 90 may include a knurled surface, a slotted surface, a plurality of bumps, ridges, rib, grooves, or any surface feature that may facilitate contact between the sleeve 90 and the coupling member 30. In many embodiments, the inner surface features of the sleeve 90 and the outer surface features 38 of the coupling member 30 may structurally correspond with each other. For example, the inner geometry of the sleeve 90 may reflect and/or structurally correspond with the outer geometric shape of the coupling member 30. Due to the engagement between the sleeve 90 and the coupling member 30, a user may simply grip and rotate/twist the sleeve 90 to thread the coupling element 30 onto an interface port, such as interface port 20. Additionally, the sleeve 90 may include an annular ramped surface 95 or chamfer proximate or otherwise near the first end 91 to accommodate an increased diameter or general size of the coupling member 30 proximate a second, rearward end 32 of the coupling member 30. Embodiments of the ramped surface 95 may be structurally integral with the engagement member 97 and the body of the sleeve 90. Further still, embodiments of the sleeve 90 may include outer surface features, such as annular serrations or slots, configured to enhance gripping of the sleeve 90 while connecting the connector 100 onto an interface port. The sleeve 90 may be formed of materials such as plastics, polymers, bendable metals or composite materials that facilitate a rigid body. Further, the sleeve 90 may be formed of conductive or non-conductive materials or a combination thereof. Manufacture of the sleeve 90 may include casting, extruding, cutting, turning, drilling, knurling, stamping, injection molding, spraying, blow molding, component overmolding, combinations thereof, or other fabrication methods that may provide efficient production of the component.

FIGS. 4A and 4B depict a second embodiment of a coaxial cable connector, shown as connector 101, having a modified outer sleeve, depicted as outer sleeve 190. The outer sleeve 190 may share the same structural and functional aspects of outer sleeve 90; however, outer sleeve 190 may be configured to engage with the connector body 50, as opposed to engaging the coupling member 30. The outer sleeve 190 may share an interference fit with the connector body. Furthermore, the outer sleeve 190 may move with the compression of the connector body 50 to cover openings 56 to preventingress of moisture or other environmental elements. Similar to outer sleeve 90, the outer sleeve 190 may cover the connector body 50 to block moisture entry paths of the connector body 50 if outdoor use is intended, or to block dust and other contaminants in an indoor environment. However, as shown in FIG. 5, a connector, such as connector 102, may not include an outer sleeve 90, 190 to reduce the number of components in the assembled configuration of the connector.

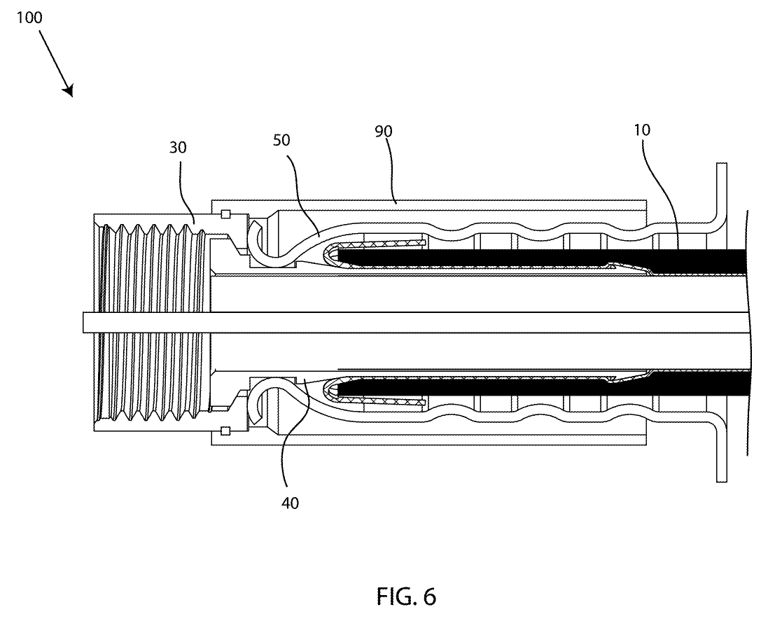

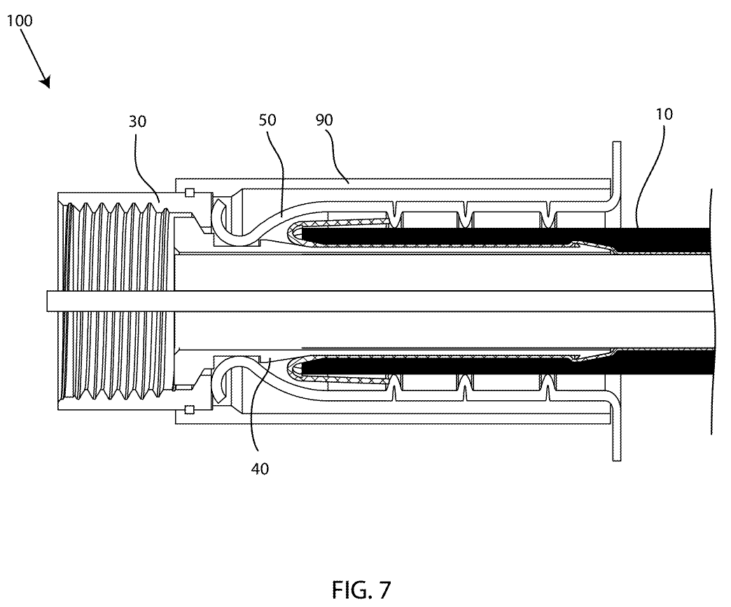

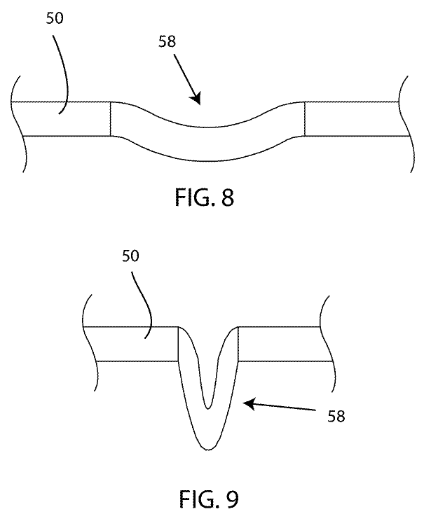

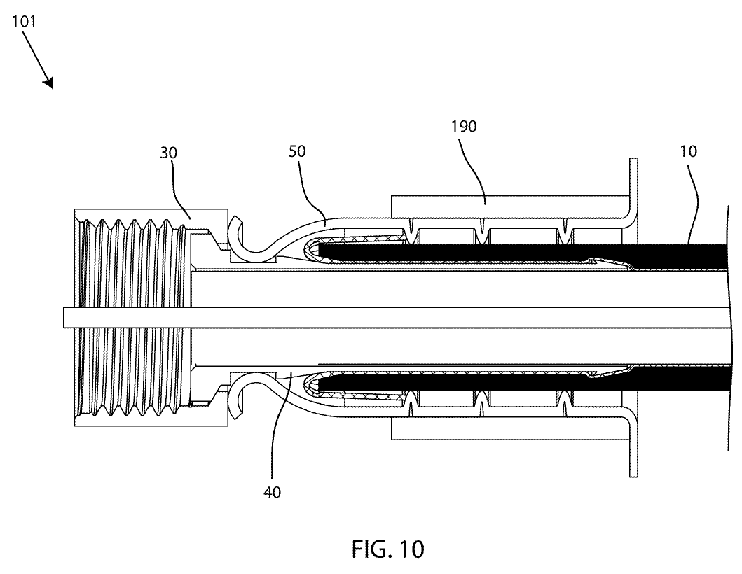

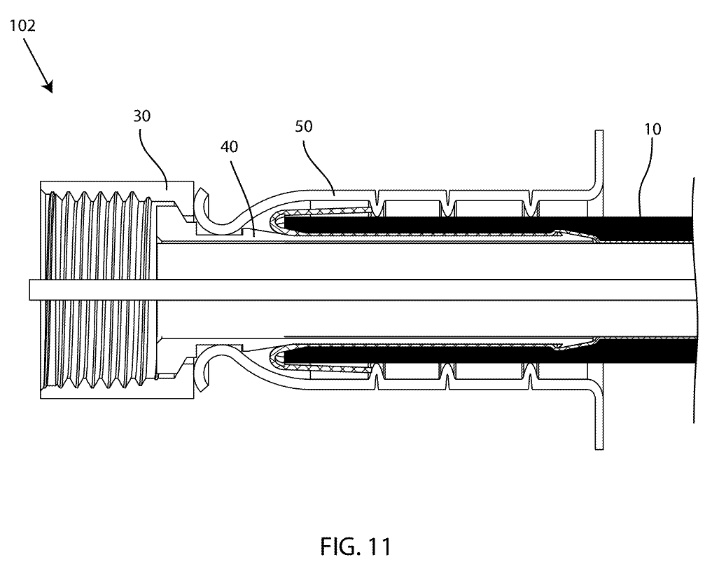

With reference to FIGS. 6-9, the manner in which the connector body 50 fastens to the cable 10 will now be described. FIG. 6 depicts an embodiment of connector 100, wherein the connector body 50 is in a first position, and the cable 10 has been inserted within the connector 100 but not yet securely fastened to the connector 100. The first position may reflect a position prior to axial compression of the connector body 50. As can be seen in FIG. 8, the weakened portions 58 between the openings 56 are in an original, unbuckled position, not yet securely contacting the cable jacket 12. FIG. 7 depicts an embodiment of connector 100, wherein the connector body 50 is in a second position, securely fastened to the cable 10. The second position may reflect a position after axial compression of the connector body 50. As can be seen in FIG. 9, the weakened portions 58 between openings 56 are in a securing position with respect to the cable jacket 12, buckled inward to securely grip the cable jacket 12. To achieve the second position of the connector body 50 from the first position of the connector body 50, an installer can axially compress the connector 50, typically using a compression tool (not shown) known to those skilled in the art. The axial compression of the connector body 50 may be done at a very low, and very consistent, force due to the thin wall thickness resulting from the drawing process when manufacturing the connector body 50. FIGS. 10 and 11 show connector 101 and connector 102, respectively, in a second position, wherein the connector body 50 is securely fastened to the cable 10.

Referring now to FIGS. 1-11, a method of securing or fastening a connector body 50 to a coaxial cable 10, may include the steps of providing a connector body 50 having a body portion 50a, forming one or more weakened portions 58 across the body portion 50a of the connector body 50 to structurally weaken the body portion 50a along a discontinuous revolution around the body portion 50a, wherein the forming of the one or more weakened portions 58 across the body portion 50a of the connector body 50 may facilitate a collapse of the body portion 50a when the connector body 50 is axially compressed, further wherein the collapse of the body portion 50a in a radially inward direction towards the coaxial cable 10 can securely fasten the connector body 50 and/or connector 100 to the coaxial cable 10.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

What is claimed is:

1. A connector body comprising;
a body portion having one or more weakened portions disposed across the body portion to structurally weaken the body portion along a discontinuous revolution around the body portion;
wherein upon axial compression of the connector body, the one or more weakened portions of the body portion buckle inward towards a coaxial cable to securely fasten the coaxial cable connector to the coaxial cable.

2. The connector body of claim 1, wherein the one or more weakened portions of the body portion are separated by one or more openings of the body portion.

3. The connector body of claim 2, wherein the one or more openings provide a view of the coaxial cable when the coaxial cable connector is in an assembled position and when in a compressed position.

4. The connector body of claim 1, further comprising:
an annular flange located at the second end of the body portion.

5. The connector body of claim 1, further comprising
a continuity portion configured to contact a portion of a coupling member of the coaxial cable connector to extend electrical continuity therebetween.

6. The connector body of claim 4, wherein the continuity portion is an integral resilient member proximate a first end of the body portion.

7. The connector body of claim 1, wherein the body portion is conductive.

8. A connector body for a coaxial cable connector, the connector body comprising:
a body portion having a first end and a second end;
a plurality of weakened body portions disposed circumferentially around the body portion; and
a plurality of openings in the body portion located between the plurality of weakened body portions;
wherein the plurality of weakened body portions are configured to buckle in a radially inward direction upon axial compression of the connector body to engage a cable jacket of a coaxial cable, thereby fastening the connector body to the coaxial cable.

9. The connector body of claim 8, further comprising:
an annular flange located at the second end of the body portion.

10. The connector body of claim 8, further comprising
a continuity portion, the continuity portion configured to contact a portion of a coupling member of a the coaxial cable connector to extend electrical continuity therebetween.

11. The connector body of claim 10, wherein the continuity portion is an integral resilient member proximate the first end of the body portion.

12. The connector body of claim 8, wherein the body portion is conductive.

13. The connector body of claim 8, wherein the one or more openings provide a view of the coaxial cable when the coaxial cable connector is in an assembled position and when in a compressed position.

14. A coaxial cable connector configured to securely attach to a coaxial cable comprising;
a coupling member operably attached to a post, the post configured to receive a prepared end of the coaxial cable;
a collapsible connector body having one or more weakened portions disposed across a body portion of the collapsible connector body; and
a sleeve member configured to radially surround at least a portion of the collapsible connector body;
wherein upon axial compression of the connector body, the one or more weakened portions of the connector body buckle inward towards the coaxial cable to securely fasten the coaxial cable connector to the coaxial cable.

15. The coaxial cable connector of claim 14, wherein the one or more weakened portions of the collapsible connector body are separated by one or more openings on the collapsible connector body.

16. The coaxial cable connector of claim 14, wherein the one or more openings provide a view of the coaxial cable when the coaxial cable connector is in an assembled position and when in a compressed position.

17. The coaxial cable connector of claim 14, wherein the collapsible connector body further comprises:
a continuity portion configured to contact a portion of the coupling member to extend electrical continuity therebetween.

18. A method of securing a connector body to a coaxial cable, comprising:
providing a connector body having a body portion; and
forming one or more weakened portions across the body portion of the connector body to structurally weaken the body portion along a discontinuous revolution around the body portion;
wherein the forming of the one or more weakened portions across the body portion of the connector body facilitates a collapse of the body portion when the connector body is axially compressed, further wherein the collapse of the body portion in a radially inward direction towards the coaxial cable securely fastens the connector body to the coaxial cable.

19. The method of claim 18, further comprising:
forming one or more openings alongside the one or more weakened portions of the body portion of the connector body.

20. The method of claim 18, further comprising:
forming an integral biasing continuity member from the body portion of the connector body, the integral biasing continuity member configured to resiliently contact a portion of a coupling member of the coaxial cable connector to extend electrical continuity therebetween.
